(19) United States
(12) Patent Application Publication
(10) Pub. No.: US 2026/0192374 A1
(43) Pub. Date: Jul. 9, 2026

(54) SAWING MACHINE WITH DETACHABLE SUPPORT BASE

(71) Applicant: DURQ MACHINERY CORP., TAICHUNG CITY (TW)

(72) Inventors: Chia-Sheng LIU, TAICHUNG CITY (TW); Chieh-Yuan TSAI, TAICHUNG CITY (TW); Shih-Hui LINE, TAICHUNG CITY (TW)

(21) Appl. No.: 19/064,403

(22) Filed: Feb. 26, 2025

(30) Foreign Application Priority Data
Jan. 3, 2025 (TW) 114100299

(51) Int. Cl. B23D 47/02; B23D 45/04; B27G 19/02

(52) U.S. Cl. CPC B23D 47/02; B23D 45/042; B27G 19/025

(57) ABSTRACT

A sawing machine includes a machine body and at least one support base detachably connected with the workbench. The machine body has a workbench with a top surface and a machining module connected to the workbench. The support base includes a main support leg with a support surface that is at the same horizontal level as the top surface of the workbench, and an auxiliary support leg pivotally connected with the main support leg so as to be pivoted relative to the main support leg. Thus, a user can detach the support base from the workbench and unfold the auxiliary support leg of the support base. The support base is then placed in a desired position to expand the operational range of the workbench, thereby supporting a larger workpiece.

### BACKGROUND OF THE INVENTION

### 1. Field of the Invention

The present invention relates to sawing machines and more particularly, to a sawing machine that has a detachable support base.

### 2. Description of the Related Art

The sawing machine is a widely used product among power tools. Depending on the speed and type of the saw blade, it can be used to cut materials such as stone, tiles, wood, or metal. Currently, there are also portable handheld circular saws or cutting machines, which make it convenient for users to perform cutting tasks directly on materials at the processing site. Due to the wide range of applications for sawing machines, the processed materials come in various shapes and sizes. For portability, handheld circular saws or cutting machines are typically designed to be as compact as possible. As a result, the area of their workbench is limited, making it difficult to fully place larger materials on the workbench. This leads to instability of the workpiece during processing.

To increase the area of the workbench, an extendable extension mechanism is often added to the workbench of the sawing machines. TW I552845 discloses the sawing machine that use two support units as an extension device for the workbench. One end of each support unit is connected to the workbench, and the other end of each support unit is connected to a support base placed on one side of the workbench. When a workpiece is larger, the support base and the support unit on one side can be detached and connected to the support unit on the other side, achieving a unilateral extension effect.

TW I613022 provides an auxiliary support mechanism for a circular saw, which includes two parallel guide rods, a support base, and an auxiliary support arm. One end of the guide rod is connected to the workbench, and the other end of the guide rod is connected to the support base. The auxiliary support arm is mounted on the support base. The guide rod can extend and retract relative to the workbench for driving the support base. When the workpiece is larger, the auxiliary support arm can be extended outward to assist in supporting the workpiece together with the support base.

However, the aforesaid extension mechanism needs to be housed within the workbench. As a result, the extension range is limited by the size of the sawing machine, and there is still the possibility that the areas of the workbench may be insufficient for use.

### SUMMARY OF THE INVENTION

It is one objective of the present invention to provide a sawing machine, which has a detachable support base that can be placed freely and provide a pivoting structure that offers the functionality of expansion and contraction, thereby achieving effects of multi-point support and simplified volume.

To attain the above objective, the sawing machine of the present invention comprises a machine body and a support base. The machine body has a workbench with a top surface and a machining module connected with the workbench. The support base is detachably connected to the workbench of the machine body and includes a main support leg provided with a support surface that is at the same horizontal level as the top surface of the workbench, and an auxiliary support leg pivotally connected with the main support leg so as to be pivoted relative to the main support leg.

It can be seen from the above that the user can detach the support base and rotate the auxiliary support leg relative to the main support leg to unfold the support base. This allows the main and auxiliary support legs to provide multi-point support, offering a more stable support structure. The support base is then placed in any position. If the workpiece is longer, simply position the support base away from the workbench, so that the workpiece can be placed simultaneously on the top surface of the workbench and the supporting surface of the support base. This allows both the workbench and the support base to jointly support the workpiece. When not supporting the workpiece, the auxiliary support leg can be pivoted relative to the main support leg to allow the support base to be folded and reattached to the workbench.

Preferably, the machining module includes a housing, a motor installed in the housing, a saw blade connected to the motor, a saw blade guard attached to the housing, and a handle fixed to the housing. In this way, the machining module drives the saw blade to rotate through the motor, and the user holds the handle to operate it to perform sawing operations.

Preferably, the machine body further has an arm with one end pivotally connected with the workbench through a lower shaft, and an opposite end pivotally connected with the machining module through an upper shaft. In this way, the arm drives the machining module to move forward or backward through the lower shaft, and the machining module can be pivoted downward relative to the arm through the upper shaft for performing sawing operations.

Preferably, the main support leg further includes a top wall provided with the support surface, two leg portions extending downward from the top wall and located at one side of the top wall, an accommodation space formed below the top wall and receiving the auxiliary support leg, and a first pivot hole provided on a bottom side of the top wall. In this way, the support base provides two support points through the two leg portions, and the accommodation space is used to accommodate the auxiliary support leg to achieve the advantage of compact size.

Preferably, a side wall and a lower grip portion provided on a bottom side of the side wall are formed between the two leg portions of the main support leg and the top wall of the main support leg. An end wall is formed between each of the leg portions of the main support leg and the top wall of the main support leg. In this way, the side wall and the end walls enhance the structural strength of the main support leg, while the lower grip portion provides the user with a better holding position, making it easier to move the support base.

Preferably, the main support leg further includes an upper grip portion recessed from the support surface of the top wall toward the side wall. In this way, the user can hold the upper grip portion and the lower grip portion at the same time to move the support base with a comfortable holding position.

Preferably, the leg portions of the main support leg each have a bottom hole inserted by a main foot pad. In this way, the main support leg contacts the tabletop or the ground through the main pad foot, preventing the leg portion from directly contacting the tabletop or the ground. This helps avoid wear on the leg portions caused by vibrations from the sawing machine, which could otherwise lead to misalignment between the support surface of the support base and the top surface of the workbench.

Preferably, one end of the auxiliary support leg has a second pivot hole and the other end of the auxiliary support leg has a perforation. An auxiliary foot pad is movably inserted in the perforation. A pivoting member is inserted through the first and second pivot holes. In this way, the auxiliary support leg provides a support point through the auxiliary pad foot, and the auxiliary support leg can be adjusted its height within the perforation to match the horizontal position of the main support leg. Additionally, through the pivoting member, the auxiliary support leg can be pivoted relative to the main support leg, allowing it to be shifted between the usage and storage configurations.

Preferably, the main support leg further has an insertion member provided on the bottom side of the top wall. In this way, the support base can be assembled with the workbench through the insertion member, and when the support base needs to be used independently, it can also be easily removed from the workbench.

Preferably, the workbench further has an insertion portion protruding from a lateral side of the workbench and an insertion slot formed on the insertion portion and detachably engaged with the insertion member of the support base. In this way, the insertion member of the support base can be inserted into the insertion slot, allowing the insertion portion to limit the insertion member. When the support base is not in use, it is stored at one side of the workbench in a compact state.

Preferably, the main support leg further has a pressure plate provided on the bottom side of the top wall and pressed against the insertion portion of the workbench. In this way, due to the slight elasticity of the pressure plate, when the support base is stored at one side of the workbench, the pressure plate presses against the outer surface of the insertion portion. The rebound force applied by the pressure plate tightens the insertion portion, ensuring that the support base is securely positioned on the workbench.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of a sawing machine of the present invention.

FIG. 2 is a partially exploded view of the sawing machine of the present invention.

FIG. 3 is a perspective view of a support base provided by the sawing machine of the present invention.

FIG. 4 is a perspective view of the support base provided by the sawing machine of the present invention from another angle.

FIG. 5 is a perspective view of a main support leg provided by the sawing machine of the present invention.

FIG. 6 is an exploded view of the main support leg provided by the sawing machine of the present invention.

FIG. 7 is a perspective view of an auxiliary support leg provided by the sawing machine of the present invention.

FIG. 8 is an exploded view of the auxiliary support leg provided by the sawing machine of the present invention.

FIG. 9 is an exploded view of the support base and the main support leg provided by the sawing machine of the present invention.

FIG. 10 is a partially sectional view of the sawing machine of the present invention, showing that the pressure plate is pressed against the insertion portion.

FIG. 11 is similar to FIG. 1, showing that a workpiece is supported by the support base when the support base is in a storage state.

FIG. 12 is similar to FIG. 11, showing that a workpiece is supported by the support base when the support base is in an expanded state.

### DETAILED DESCRIPTION OF THE INVENTION

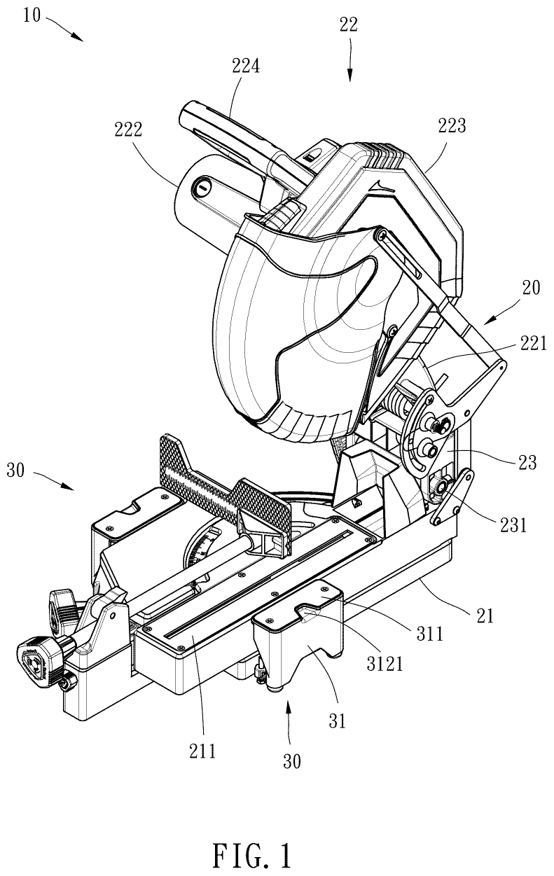

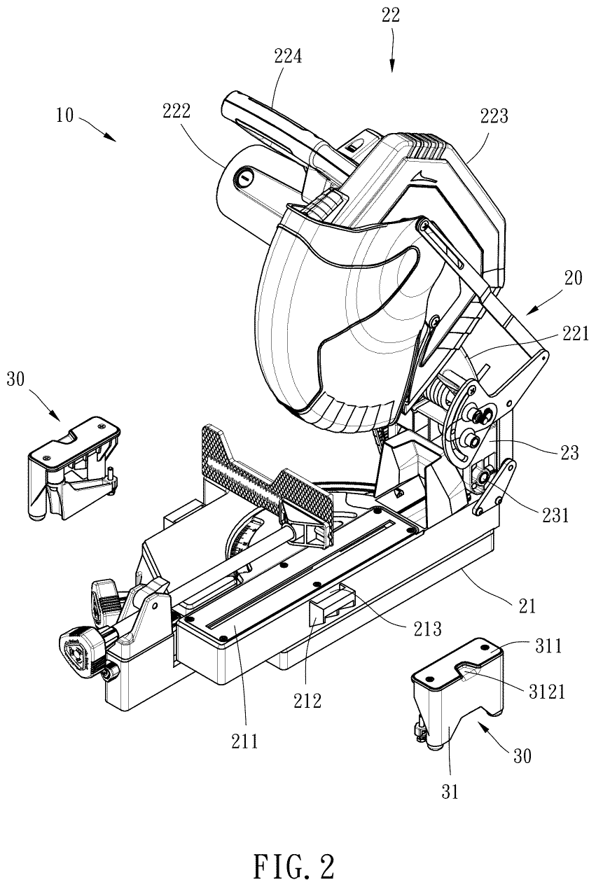

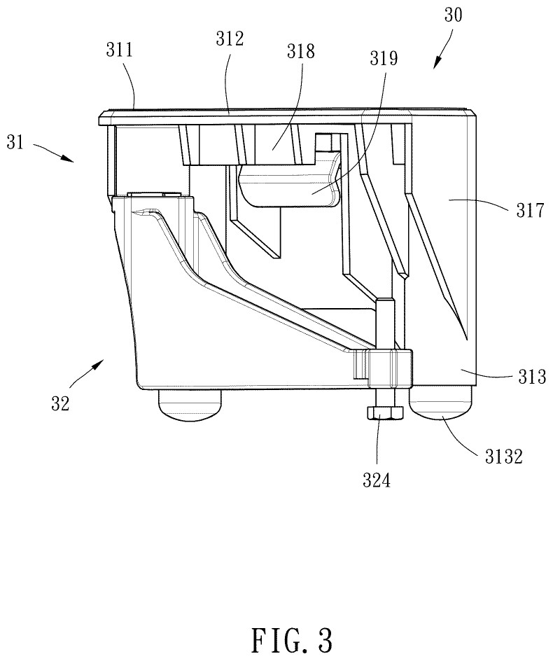

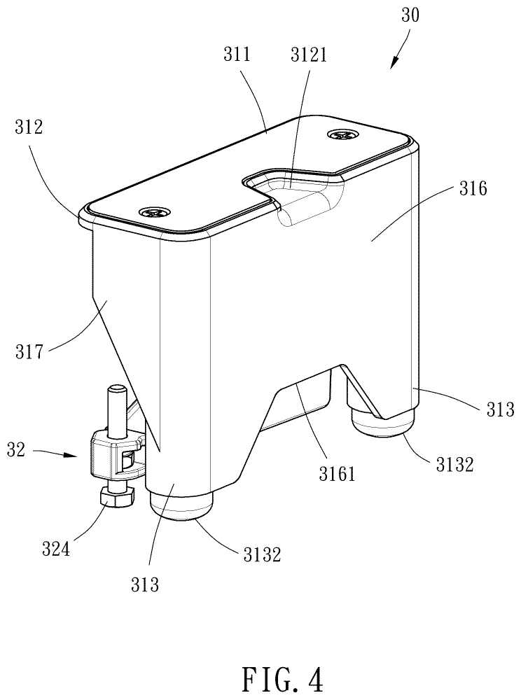

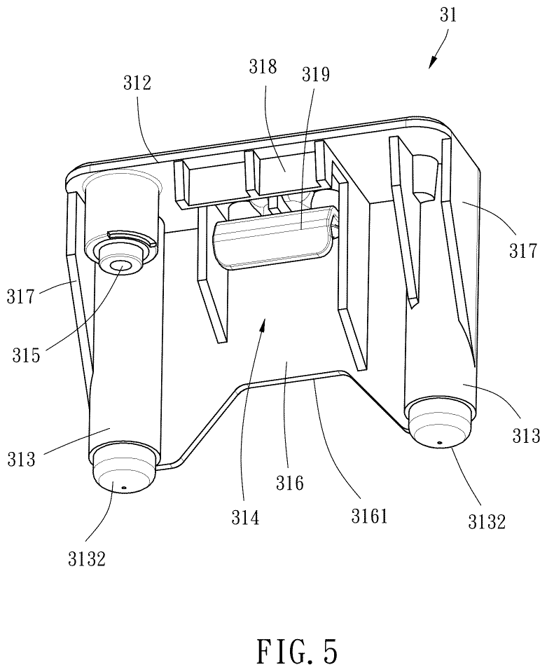

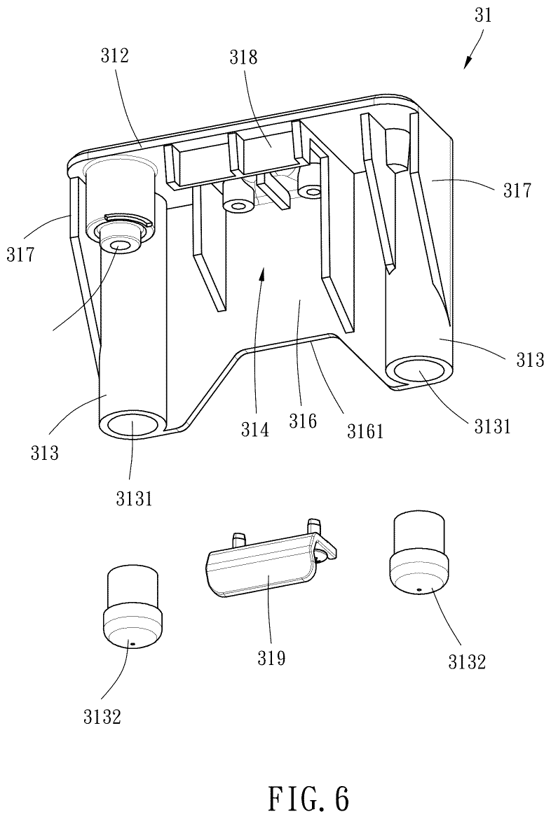

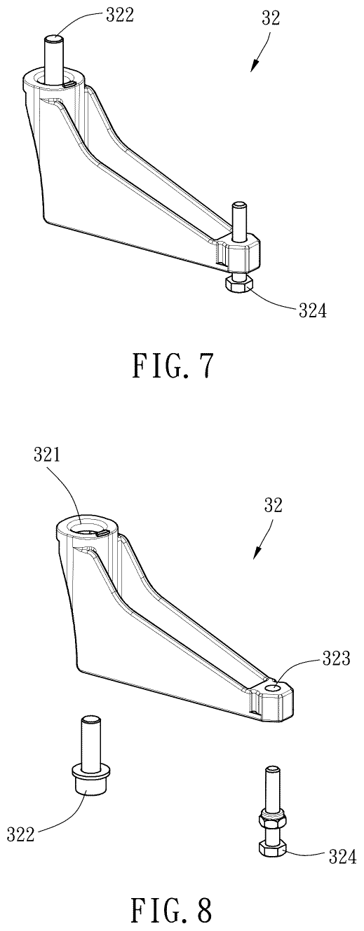

Referring to FIGS. 1 to 8, a sawing machine 10 of the present invention comprises a machine body 20 and at least one support base 30. In the following embodiment, two support bases 30 are used for illustration in conjunction with the drawings.

The machine body 20 includes a workbench 21, a machining module 22, and an arm 23. The workbench 21 has a top surface 211, and the left and right sides of the workbench 21 each have an insertion portion 212 and an insertion slot 213 formed on the insertion portion 212. The machining module 22 includes a housing 221, a motor 222 installed in the housing 221, a saw blade (not shown) connected with the motor 222, a saw blade guard 223 attached to the housing 221, and a handle 224 fixed to the housing 221. The arm 23 has an H-shaped structural appearance. The bottom end of the arm 23 is pivotally connected with workbench 21 through a lower shaft 231, and the top end of the arm 23 is pivotally connected with the machining module 22 through an upper shaft (not shown).

The support bases 30 are disposed at the left and right sides of the workbench 21, and the support bases 30 each have a main support leg 31 and an auxiliary support leg 32.

The support leg 31 includes a top wall 312, two leg portions 313, an accommodation space 314, a first pivot hole 315, a side wall 316, two end walls 317, an insertion member 318, and a pressure plate 319. The top wall 312 is formed on the top side of the support base 30 and has a support surface 311 that is at the same horizontal level as the top surface 211 of the workbench 21. The leg portions 313 extend downward from the top wall 312 and located at two ends of the top wall 312. The accommodation space 314 is formed below the top wall 312 and surrounded by the side wall 316 and two end walls 317. The first pivot hole 315 is located below the top wall 312 and adjacent to one of the leg portions 313. The side wall 316 is located between the two leg portions 313 and connected with the two leg portions 313 and the top wall 312. A lower grip portion 3161 is formed on the bottom side of the side wall 316, and an upper grip portion 3121 is recessed downward from the support surface 311 toward the side wall 316. The end wall 317 is connected with the outer surface of the leg portion 313 and the bottom side of the top wall 312. The insertion member 318 is connected with the bottom side of the top wall 312 and spaced away from the side wall 316. The pressure plate 319 is connected with the bottom side of the top wall 312 and adjacent to the side wall 316. A bottom hole 3131 is formed on the bottom end of each leg portion 313. A main foot pad 3132, which can be made of a soft material, is fixed at a top end within the bottom hole 3131, allowing a bottom end to make contact with the tabletop or the ground. This helps reduce wear on the tabletop or ground caused by the sawing machine 10.

The auxiliary support leg 32 has a L-shaped structural appearance. One end of the auxiliary support leg 32 has a second pivot hole 321. A pivoting member 322 is inserted through the first pivot hole 315 of the main support leg 31 and the second pivot hole 321 of the auxiliary support leg 32, so that the auxiliary support leg 32 can be pivoted relative to the main support leg 31, thereby completing the unfolding and folding movements. When the support base 30 is folded, the auxiliary support leg 32 is received in the accommodation space 314 of the main support leg 31. The other end of the auxiliary support leg 32 has a perforation 323. An auxiliary foot pad 324, which can use a flat-head screw, is inserted into the perforation 323. The height of the auxiliary foot pad 324 is adjusted based on the depth at which it is locked within the perforation 323 to match the horizontal position of the main pad foot 3132 of the main support leg 31.

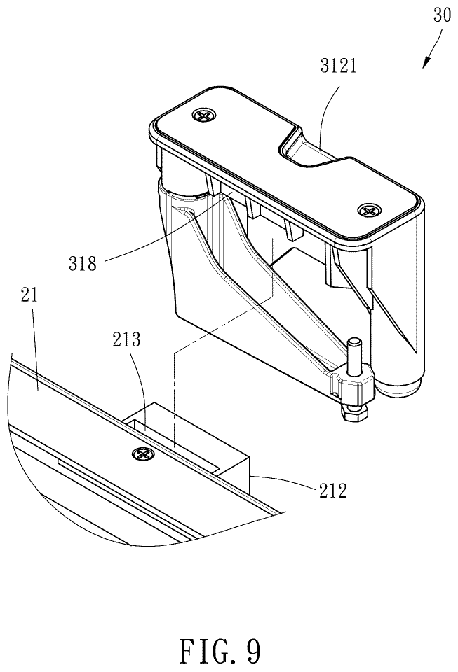

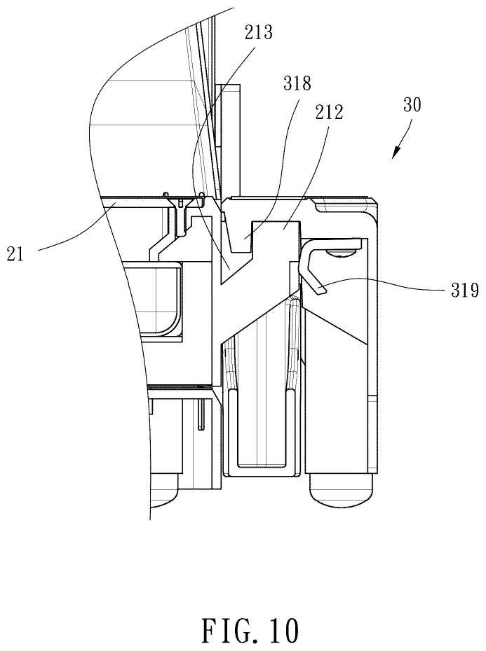

As shown in FIGS. 9-10, the support base 30 is mounted onto the workbench 21 of the machine body 20 in a top-down direction, allowing the insertion member 318 of the support base 30 to be inserted into the insertion slot 213 of the workbench 21. At this point, there will be a section of the insertion portion 212 between the insertion member 318 and the pressure plate 319. As the insertion member 318 is inserted into the insertion slot 213, the pressure plate 319 comes into contact with the outer surface of the insertion portion 212. Due to its inherent elasticity, the pressure plate 319 is slightly deflected toward the side wall 316 and moved along the outer surface of the insertion portion 212. When the bottom surface of the top wall 312 of the support base 30 makes contact with the top surface of the insertion portion 212, the assembly is complete. At this point, the pressure plate 319 presses against and tightly clamps the outer surface of the insertion portion 212, creating a clamping effect that securely holds the insertion portion 212. This increases the stability of the support base 30 being fixed to the workbench 21.

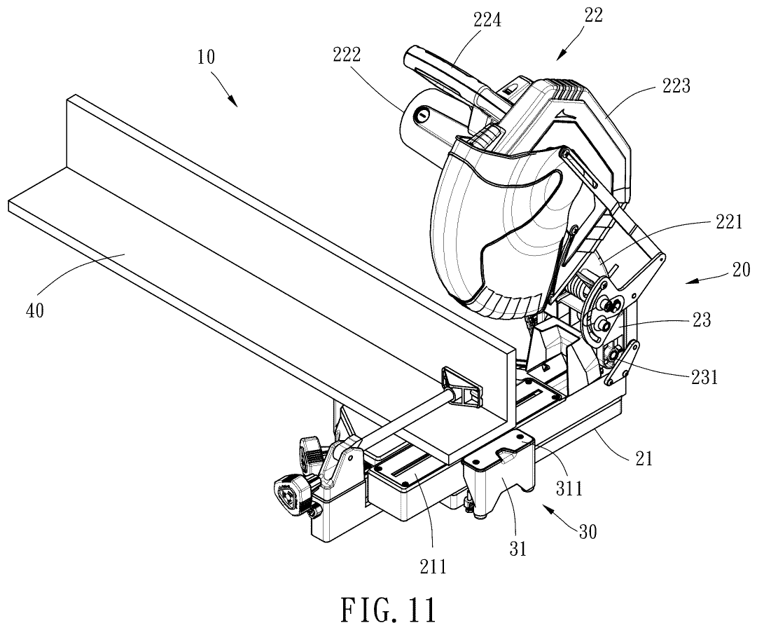

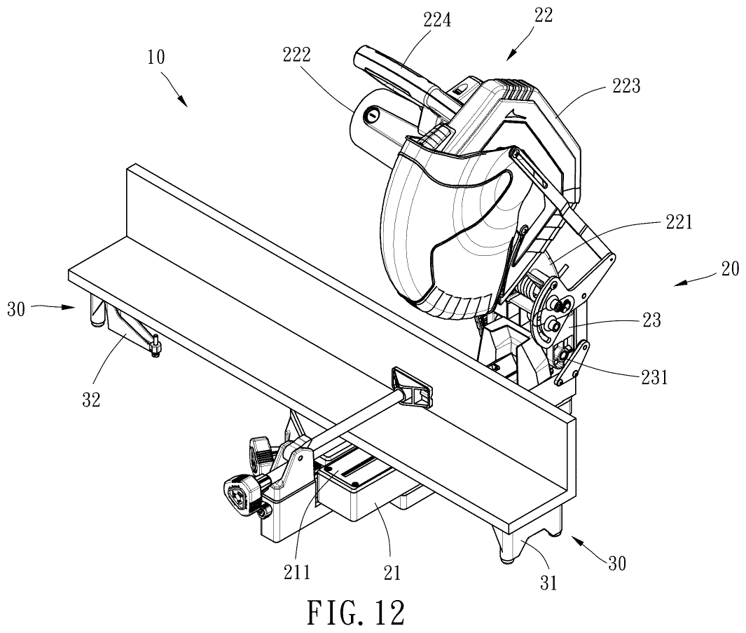

In this embodiment, the support base 30 has a storage configuration for use with the workbench 21, as shown in FIG. 11, and an expanded configuration for independent use when separated from the workbench 21, as shown in FIG. 12. In the case of a shorter workpiece 40, the workpiece 40 can be directly placed on the top surface 211 of the workbench 21, with both ends of the workpiece 40 resting on the supporting surfaces 311 of the support bases 30 on either side of the workbench 21, allowing the machining module 22 to perform sawing operations.

In the case of a longer workpiece 40, the support base 30 needs to be separated from the workbench 21 for use. First, the user grips the lower grip part 3161 and the upper grip part 3121 of the support base 30 with their fingers, and then lifts the support base 30 from bottom to top. This causes the insertion member 318 of the support base 30 to be detached from the insertion slot 213 of the workbench 21, while the pressure plate 319 is moved along the outer surface of the insertion portion 212. Once the support base 30 is completely separated from the workbench 21, the auxiliary support leg 32 is pivoted outward to a position perpendicular to the main support leg 31, as shown in FIG. 12. The user then places the workpiece 40 on the top surface 211 of the workbench 21 and the supporting surface 311 of the support base 30, and uses the machining module 22 to perform sawing operation. The support base 30 is supported by three support points: two from the main support legs 31 and one from the auxiliary support leg 32. This configuration of three support points provides a stable and secure support effect.

After use, the user simply needs to rotate the auxiliary support leg 32 inward relative to the main support leg 31. The auxiliary support leg 32 is folded into the accommodating space 314 of the main support leg 31. At this point, the support base 30 is in a storage state with the auxiliary support leg 32 parallel to the main support leg 31. The support bases 30 can then be reattached to the left and right sides of the workbench 21 to complete the storage.

Based on the above, the sawing machine 10 of the present invention, compared to the prior art, has at least the following advantages:
1. The support base 30 is detachably assembled to the workbench 21 of the machine body 20, allowing the support base 30 to be completely separated from the workbench 21 and placed in a suitable position for use. This structural design enables the extension distance of the support base 30 to not be limited by the size of the sawing machine 10, making the sawing machine 10 more adaptable for workpieces 40 of various sizes.
2. The auxiliary support leg 32 can be pivoted relative to the main support leg 31. When the support base 30 is expanded, both the main support leg 31 and the auxiliary support leg 32 provide support points simultaneously, offering better support. When the support base 30 is folded, its compact size allows it to be stored on the workbench 21, preventing it from occupying excessive space.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A sawing machine comprising:
a machine body having a workbench with a top surface and a machining module connected with the workbench; and
a support base detachably connected to the workbench of the machine body and including a main support leg provided with a support surface that is at the same horizontal level as the top surface of the workbench, and an auxiliary support leg pivotally connected with the main support leg so as to be pivoted relative to the main support leg.

2. The sawing machine as claimed in claim 1, wherein the machining module includes a housing, a motor installed in the housing, a saw blade connected to the motor, a saw blade guard attached to the housing, and a handle fixed to the housing.

3. The sawing machine as claimed in claim 1, wherein the machine body further has an arm with one end pivotally connected with the workbench through a lower shaft, and an opposite end pivotally connected with the machining module through an upper shaft.

4. The sawing machine as claimed in claim 1, wherein the main support leg further includes a top wall provided with the support surface, two leg portions extending downward from the top wall, an accommodation space formed below the top wall and receiving the auxiliary support leg, and a first pivot hole provided on a bottom side of the top wall.

5. The sawing machine as claimed in claim 4, wherein a side wall and a lower grip portion provided on a bottom side of the side wall are formed between the two leg portions of the main support leg and the top wall of the main support leg, and an end wall is formed between each of the leg portions of the main support leg and the top wall of the main support leg.

6. The sawing machine as claimed in claim 5, wherein the main support leg further includes an upper grip portion recessed from the support surface of the top wall toward the side wall.

7. The sawing machine as claimed in claim 4, wherein the leg portions of the main support leg each have a bottom hole inserted by a main foot pad.

8. The sawing machine as claimed in claim 4, wherein one end of the auxiliary support leg has a second pivot hole and the other end of the auxiliary support leg has a perforation; an auxiliary foot pad is movably inserted in the perforation; a pivoting member is inserted through the first and second pivot holes.

9. The sawing machine as claimed in claim 4, wherein the main support leg further has an insertion member provided on the bottom side of the top wall.

10. The sawing machine as claimed in claim 9, wherein the workbench further has an insertion portion protruding from a lateral side of the workbench and an insertion slot formed on the insertion portion and detachably engaged with the insertion member of the support base.

11. The sawing machine as claimed in claim 10, wherein the main support leg further has a pressure plate provided on the bottom side of the top wall and pressed against the insertion portion of the workbench.
